(19) United States
(12) Patent Application Publication
(10) Pub. No.: US 2007/0166420 A1
(43) Pub. Date: Jul. 19, 2007

(54) Process for producing a raw mixture for sintering

(76) Inventors: Oskar Pammer, Linz (AT); Hans Herbert Stiasny, Linz (AT)

Correspondence Address: OSTROLENK FABER GERB & SOFFEN, 1180 AVENUE OF THE AMERICAS, NEW YORK, NY, 100368403, US

(21) Appl. No.: 10/591,564

(22) PCT Filed: Feb. 23, 2005
(86) PCT No.: PCT/EP05/01880

§ 371 Date: Sep. 1, 2006

(30) Foreign Application Priority Data
Mar. 3, 2004 (AT) A 347/2004

(51) Int. Cl. B29C 31/10; B29B 9/06

(52) U.S. Cl. 425/130; 264/118

(57) ABSTRACT

A raw mixture for sintering, containing ore with a fines fraction, at least one addition, returned sintered material from a subsequent sintering process and optionally a binder produced by mixing followed by granulation. To achieve high throughput capacities while avoiding wear to installation parts and resultant operating failures, the returned sintered material is added after the ore has been mixed with the addition and with the optional binder.

The invention relates to a process for producing a raw mixture for sintering, containing ore with a fines fraction, at least one addition, returned sintered material from a subsequent sintering process and optionally a binder, by mixing and granulation, and to an installation for carrying out the process.

Processes of the type described in the introduction are known, for example, from EP 0 199 818 A1, JP 62-174333 A, EP 0 415 146 A1 and from ISIJ International, Vol. 33 (1993), No. 4, pages 454 to 461. In all these known processes, the comminution of the sintered material required after sintering produces a fines fraction of the sintered material, which has a disadvantageous effect during the subsequent processing of the sintered ore. This fines fraction, also referred to below as the returned sintered material, is therefore returned and added to the charge material, i.e. the ore with a fines fraction and the addition, then mixed and granulated again and subsequently sintered.

The returned sintered material is extremely abrasive and causes a high level of abrasion to the installation parts with which the returned sintered material comes into contact during production of the raw mixture for sintering. Significantly increased abrasion to installation parts of this type results in particular if it is attempted to achieve a high quantitative throughput per unit time. This then results in premature wear to installation parts and therefore to poor utilization of an installation for producing raw mixtures for sintering of this type.

Therefore, the invention is based on the object of providing a process and an apparatus for carrying out the process which, despite returning returned sintered material, allow high throughput capacities while at the same time making it possible to avoid operating shutdowns caused by the failure of important parts of the installation and also allowing maintenance intervals which are not too close together.

According to the invention, this object is achieved by the fact that the returned sintered material is added after the ore has been mixed with the addition and with the optional binder.

It has been found that by bypassing the mixing process when returning the returned sintered material, the availability of an installation for producing a raw mixture for sintering is greatly increased and, moreover, enormous increases in capacity can be achieved in an installation of this type. For example, it is possible to achieve an installation with a throughput of more than 500 t/h.

Furthermore, the addition of the returned material only immediately before granulation or even during granulation is advantageous for the granulation operation sequence, since on the one hand the coarser particles of the returned sintered material function as a nucleus for the granules to be formed and since on the other hand the fines fraction of the returned material serves as a required constituent for the formation of the granules during the rerolling.

According to a first preferred embodiment, the returned sintered material is added prior to granulation. However, this does not mean that the returned sintered material is added as early as during mixing if initial granules should form as early as during mixing. Rather, the returned sintered material is added prior to what is known as a final granulation process, in which granules of the desired size are formed from the mixed material, even if the mixed material already contains some smaller granules which were formed during mixing. For example, the returned sintered material may be added as the mixed material is being transported from a mixing device to a granulating device.

According to a further preferred embodiment, the returned sintered material is added during the granulation process, preferably during the final granulation process.

It is preferable for the point at which the returned sintered material is added to be variable, i.e. for it to be possible to set this location from after mixing to just before completion of the granules. This makes the process very adaptable to satisfy the different operating states. By way of example, some of the returned sintered material may be added prior to granulation and some during granulation. However, it is also possible, when using a granulating drum, to make the location at which the returned sintered material is introduced into the granulating drum variable, so that the returned sintered material can be introduced either at the start of the formation of granules or only at a subsequent process stage.

It is preferable for a fuel to be added during a stage of the granulation in which unsintered granules which are forming are of the size which is desired for further processing, as explained, for example, in Austrian Patent Application A 1110/2003.

According to a particularly preferred embodiment, the mixing is carried out as intensive mixing in which the material to be mixed is mixed in a container by means of a mixing tool, with a relative movement taking place between the container and the mixing tool. It has been found that the abrasion caused by returned sintered material is particularly pronounced when using intensive mixing, and consequently it is particularly advantageous for intensive mixing to be combined with return of the returned sintered material downstream of the intensive mixing. Intensive mixing allows particularly high throughput capacities to be achieved. This is because it causes the particles which are to be mixed to be brought together particularly vigorously and quickly, so that a subsequent granulation process likewise takes place at an accelerated pace. A further advantage is the homogeneous distribution of the mixed particles, thereby ensuring a very good quality of a sintered material. The measure according to the invention prevents the returned sintered material from imposing a burden on an intensive mixer.

Moreover, the use of intensive mixing results in a high productivity and a reduction in the energy consumption at the sintering installation. Furthermore, this makes it possible to produce a very good and stable quality of sintered material, which has a very positive influence on the productivity and energy consumption during the subsequent further processing of a sintered ore, for example in a blast furnace.

An installation for producing a raw mixture for sintering, containing ore with a fines fraction, at least one addition, returned sintered material from a subsequent sintering process and optionally a binder, which installation has a mixer for mixing the ore, the addition and the binder which is optionally added, and downstream of which mixer there is a pelletizing device, is characterized in that the pelletizing device is designed as a granulating drum, and in that a delivery device which feeds returned sintered material to the mixture is provided.

It is preferable for the delivery device for returned sintered material to lead to a delivery device which leads from the mixer to the granulating drum.

However, it may also be advantageous for a delivery device which returns returned sintered material to project into the granulating drum, in which case the discharge location of the delivery device for discharging the returned sintered material is advantageously variable within the longitudinal extent of the granulating drum, and in which case, furthermore, it is expedient for the delivery rate of the delivery device for the returned sintered material to be variable.

The mixer used may be a drum mixer, but a particularly preferred variant is characterized in that the mixer is designed as an intensive mixer, the mixer having a container into which a mixing tool projects, it being possible to set a relative movement between the container and the mixer tool.

In this case, the mixer is expediently designed as a horizontal or vertical shaft mixer with blades or paddles arranged on at least one shaft.

It is preferable for an addition device for adding fuel, such as coke, to be provided within the granulating drum, in which case the discharge location of the addition device is provided downstream of the discharge location for discharging the returned sintered material, as seen in the direction in which the raw mixture for sintering is conveyed.

It is also possible for the mixer to be formed integrally with the granulating drum, in which case a first part of the device, as seen in the throughput direction of the material to be mixed, is designed as a mixer, in particular as an intensive mixer, and a further part is designed as a granulating drum.

As has already been mentioned above, the invention allows high capacities to be achieved. An installation according to the invention can therefore be designed for a capacity of more than 500 t/h of raw mixture for sintering.

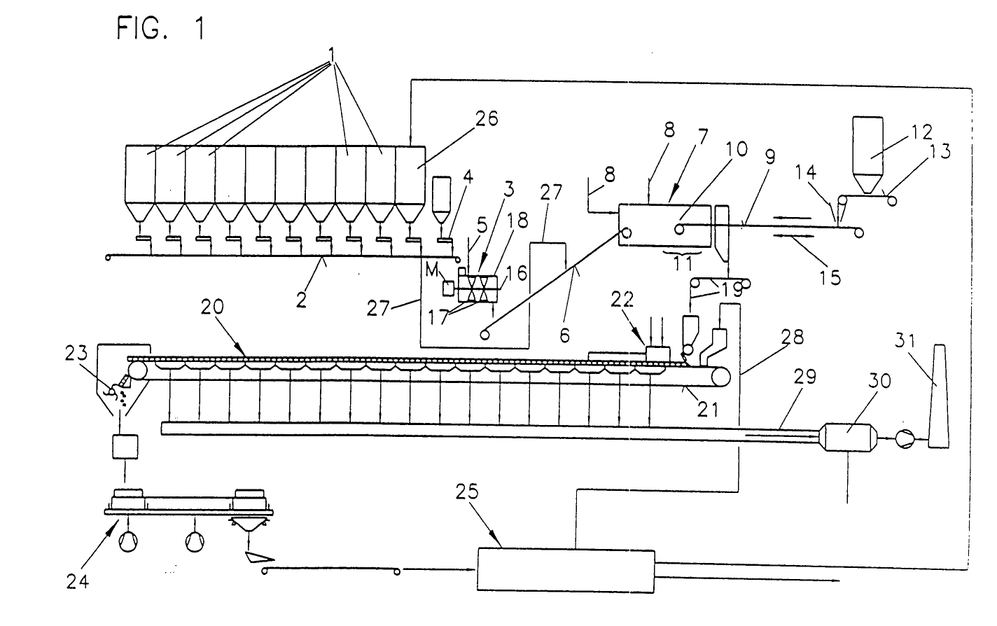

The invention is explained in more detail below on the basis of the exemplary embodiments which are diagrammatically depicted in FIGS. 1 to 3 of the drawing.

In accordance with the embodiment illustrated in FIG. 1, ores and additions, which may also include fuel, such as for example coke, as an addition, are removed in a predetermined ratio from hoppers 1 arranged next to one another using weighing devices and then pass onto a collection device, such as a conveyor belt 2, which conveys these materials to a mixer 3, which is preferably designed as a high-performance mixer, as is described in more detail below.

Immediately before these materials are added to the mixer 3, a binder, such as for example calcined lime, is additionally added to the materials via a feed 4. To optimize the mixing operation and also the agglomeration operation which is subsequently to be carried out, a defined quantity of water is added in the mixer 3 via a feed line 5 in order to obtain a defined optimum moisture level.

The mixture which is discharged from the mixer 3 passes via a conveyor device, such as a conveyor belt 6, to a granulation device 7, in which the mixture is granulated and in which the required final moisture content is also set by means of a water feed 8. The material passes from an addition end of the granulation drum 7 to the opposite discharge end, with increasing formation of unsintered granules, which are ultimately preferably to be of a size of between 2 and 8 mm, and are then conveyed onwards from the discharge end for further processing. Further processing of this type is effected by sintering, as described below.

In the example illustrated, the granulating drum 7 is arranged in a horizontal position; however, to increase the delivery capacity it may also be arranged on a slight inclination. The same also applies to the mixer 3.

It is preferable for the unsintered granules—known as unsintered pellets—to be sheathed with a fine-grain fuel, preferably fine coke, when they reach their optimum grain size of up to 8 mm. This takes place within the granulating drum 7, in which an addition device 9 for adding the fuel is provided at a defined location on the longitudinal extent of the granulating drum 7. This addition apparatus 9 is preferably designed as a conveyor belt, the discharge or ejection location 10 of which defines the region 11 at which the fuel is added to the unsintered granules. The fuel is placed onto the conveyor belt 9 via a hopper 12, a weighing belt 13 and a discharge chute 14. The fuel may be provided with a fine-grained binder, such as for example calcined lime, hydrated lime or slag.

The conveyor belt 9 preferably projects into the granulating drum 7 via one end of the latter and extends in the longitudinal direction of the granulating drum 7.

As an alternative to the conveyor belt 9, it would also be possible to use other addition devices, for example a screw conveyor or a chain trough conveyor, etc.

It is advantageous for the region 11 where the fuel is ejected, i.e. the region of initial contact between the fuel and the unsintered granules, to be variable, which can be realized by altering the conveyor belt speed, so that the ejection parabola of the fuel is altered. This can also be achieved by displacing the conveyor belt 9 in the longitudinal direction of the granulating drum 7, as illustrated by a double arrow 15 in the drawing.

Beyond the region of initial contact between the unsintered granules and the fuel, the granules are sheathed with the fuel and thereby stabilized; this prevents further growth of the unsintered granules. Any coarser fraction of the fuel, i.e. of the coke which is preferably used, which may be present is distributed between the sheathed unsintered granules.

The mixer 3 is designed as a high-performance mixer and has a horizontal, driven shaft 16, on which paddles or blades 17 extending radially outwards are arranged. When using a high-performance mixer of this type, it is possible to minimize the moisture content of the unsintered granules, thereby increasing the productivity at a sintering machine. Furthermore, the materials are particularly homogeneously distributed in the mixture, so that a uniform quality of the end product is ensured. The relative movement between the drum 18 of the high-performance mixer and the blades 17 is of considerable importance.

The unsintered pellets or unsintered granules formed in this way are then fed via a conveyor device 19 to a sintering machine 20, are placed onto the travelling grate 21 thereof and sintered after ignition by means of an ignition hood 22. At the outlet-side end of the sintering machine 20, the fully sintered material is roughly comminuted by means of a comminution device 23, then cooled by means of a cooling device 24 and transferred to a further comminution and screening installation 25. The roughly comminuted sintered material is comminuted further in this comminution and screening installation 25, generally by means of roll crushers. Particles of the order of magnitude of between 0 and 50 mm are formed. The particles which are smaller than approximately 5 mm are collected in a hopper 26 as returned sintered material and from this are added, after they have been weighed out in a defined quantity per unit time, to the mixed material emerging from the mixer 3, formed from ore, addition and binder, specifically are added to the conveyor belt 6 which connects the mixer 3 to the granulating drum 7, as is illustrated by a diagrammatically depicted conveyor device 27.

The particles, which are preferably of a size of between 10 and 20 mm, are fed to the sintering machine 20 in a predetermined quantity as a grate covering, as shown by line 28. If the quantity of particles of this size exceeds the quantity required for the grate covering, these particles are fed for further processing together with the other particles.

The off-gas which is formed during the sintering operation is fed via a collection line 29 to a gas purification device 30 and is then discharged via a chimney 31.

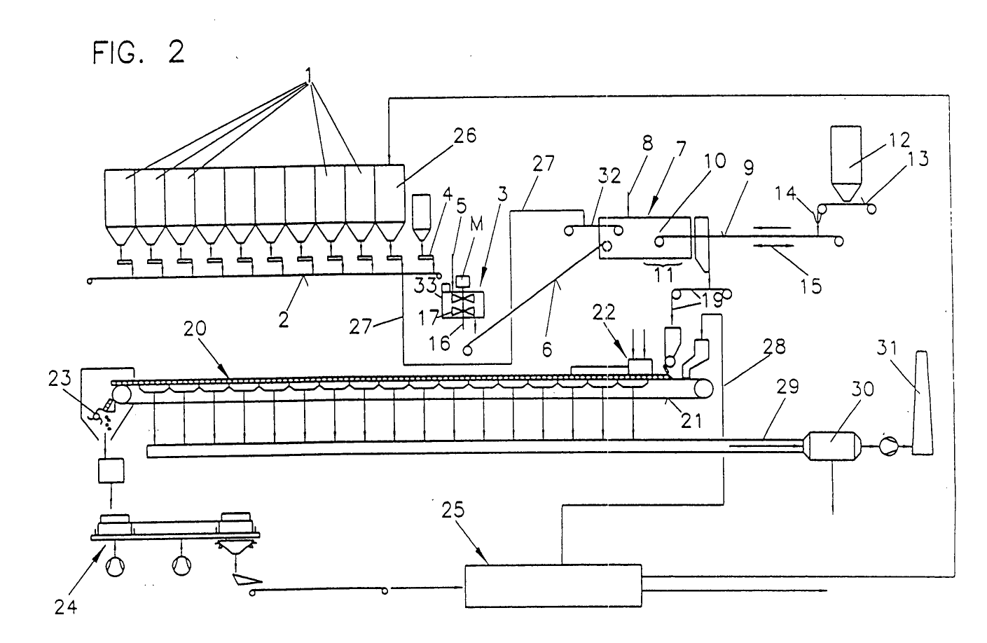

In accordance with FIG. 2, the returned sintered material is placed onto a conveyor belt 32 which projects into the granulating drum 7 and is ejected there at a predetermined location in the longitudinal extent of the granulating drum. It is possible to vary this location by longitudinal displacement of the conveyor belt 32.

In accordance with FIG. 2, the mixer 3 is likewise designed as an intensive mixer, with one or more vertically arranged shafts 16, which are driven by a motor M and have paddles 17, projecting into the container 33.

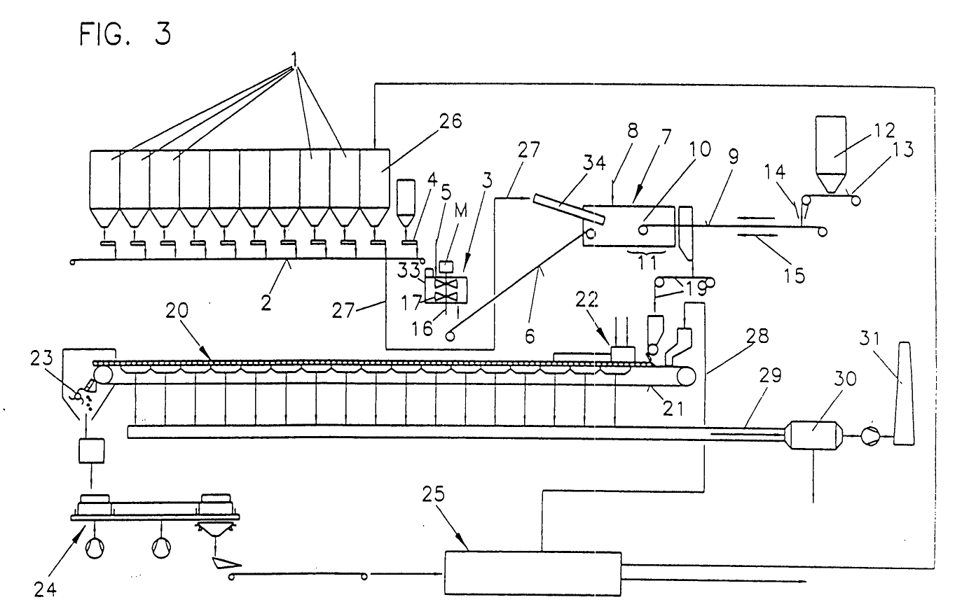

A further possible option for adding the returned sintered material is illustrated in FIG. 3; in accordance with FIG. 3, the returned sintered material is introduced into the granulating drum 7 via a chute 34.

Adding the returned sintered material after the mixing operation makes it possible to use the intensive mixers 3 described above which allow a high productivity and also enable the energy consumption to be reduced. Moreover, sintered materials with a very good and also stable quality can be produced, which in turn has a positive effect on the productivity and the energy consumption during the subsequent further processing, for example in a blast furnace.

1. A process for producing a raw mixture for sintering, comprising mixing ore with a fines fraction, at least one addition, and returned sintered material from a subsequent sintering process and optionally with a binder, comprising mixing and granulation of the mixture, and adding the returned sintered material after the ore has been mixed with the addition and optionally with the optional binder.

2. The process according to claim 1, further comprising adding the returned sintered material prior to the granulation.

3. The process according to claim 1, further comprising adding the returned sintered material during the granulation process.

4. The process according to claim 1, wherein a location at which the returned sintered material is added can be varied, to be set from after the mixing to just before completion of the granulation.

5. The process according to claim 1, further comprising adding a fuel during a stage of the granulation in which unsintered granules which are forming are of a size which is desirable for further processing of the granules.

6. The process according to claim 1, wherein the mixing comprises intensive mixing in which the material to be mixed is mixed in a container by means of a mixing tool,
and the mixing comprises a relative movement between the container and the mixing tool.

7. An installation for producing a raw mixture for sintering, wherein the mixture comprises ore with a fines fraction, at least one addition, returned sintered material from a subsequent sintering process and optionally a binder, the installation comprising a mixer for mixing the ore, the addition and the binder which is optionally added, and downstream of the mixer along a path of the mixture in the installation a pelletizing device for the mixture, wherein the pelletizing device includes a granulating drum, and a delivery device operable to return sintered material to the mixture and the delivery device opens downstream from the mixer.

8. The installation according to claim 7, wherein the delivery device for returned sintered material leads the returned sintered material to a second delivery device and the second delivery device leads the mixture from the mixer to the granulating drum.

9. The installation according to claim 7, wherein the delivery device which is operable to return returned sintered material projects into the granulating drum to return the sintered material into the granulating drum.

10. The installation according to claim 9, wherein the granulating drum extends over a longitudinal extent, and the delivery device has a sintered material discharge location for discharging the returned sintered material and the sintered material discharge location is variable within the longitudinal extent of a granulating drum.

11. The installation according to claim 7, wherein the delivery device is operable to cause a delivery rate for the returned sintered material which is variable.

12. The installation according to claim 7, wherein the mixer is an intensive mixer; the mixer includes a container and a mixer tool that projects into the container, and the container and the mixer tool are moveable relatively.

13. The installation according to claim 12, wherein the mixer comprises a horizontal or vertical shaft mixer with blades or paddles arranged on at least one shaft.

14. The installation according to claim 10, further comprising an addition device for adding fuel, the addition device being located within the granulating drum, the addition device having an addition device discharge location provided downstream of the sintered material discharge location for discharging the returned sintered material, as seen in a direction in which the raw mixture for sintering is conveyed.

15. The installation according to claim 7, wherein the mixer is formed integrally with the granulating drum.

16. The installation according to claim 7, wherein the installation has a capacity of more than 450 t/h of raw mixture for sintering.
